(19) United States
(12) Patent Application Publication
(10) Pub. No.: US 2026/0024163 A1
(43) Pub. Date: Jan. 22, 2026

(54) INITIATING APPLICATION ACTIONS ON A WEARABLE DEVICE USING CONTEXT FROM IMAGES

(71) Applicant: Google LLC, Mountain View, CA (US)

(72) Inventors: Adarsh Prakash Murthy Kowdle, San Francisco, CA (US); Jamie Alexander Zyskowski, Everett, WA (US); Dongeek Shin, San Jose, CA (US); Aveek Purohit, Palo Alto, CA (US); David Kim, Zug (CH)

(21) Appl. No.: 18/774,515

(22) Filed: Jul. 16, 2024

(51) Int. Cl. G06T 5/50; G06F 3/01; G06F 3/14; G06T 7/50; G06T 7/62

(52) U.S. Cl. CPC G06T 5/50; G06F 3/013; G06F 3/017; G06F 3/14; G06T 7/50; G06T 7/62; G06T 2207/20221

(57) ABSTRACT

According to at least one implementation, a method includes identifying a command from a user of a device. In response to the command, the method further includes identifying an image associated with a gaze of the user and identifying an action based on an application of a language model to the command and the image, the application of the language model including an identification of an object for the command in the image.

### BACKGROUND

An extended reality (XR) device incorporates a spectrum of technologies that blend physical and virtual worlds, including virtual reality (VR), augmented reality (AR), and mixed reality (MR). These devices immerse users in digital environments, either by blocking out the real world (VR), overlaying digital content onto the real world (AR), or blending digital and physical elements seamlessly (MR). XR devices include headsets, glasses, or screens equipped with sensors, cameras, and displays that track the movement of users and surroundings to deliver immersive experiences across various applications such as gaming, education, healthcare, and industrial training.

### SUMMARY

This disclosure relates to systems and methods for managing actions on a wearable device based on the application of a model to a command and imaging information for a physical environment. In at least one implementation, a user may provide a command that is identified by the device. In response to identifying the command, the device identifies an image associated with the gaze of the user (e.g., an outward-facing camera on an extended reality device). Once identified, the device identifies and initiates an action based on an application of a model to the command and the image. In some implementations, the application of the model identifies an object for the command from the image. The object may be identified based on a user's gaze toward the object in some examples. The object may be identified based on a user gesture in some examples. The object may be identified by a combination of gaze and gesture in some examples. In some implementations, the object is representative of a three-dimensional object referenced in the voice command. In some implementations, identifying the action based on the application of the model to the command and the image includes identifying content for display based on the application of the model to the command and the image. Once the content is identified, the device identifies an orientation to display the content based on the application and causes the display of the content in the orientation on a display.

In some aspects, the techniques described herein relate to a method including: identifying a command from a user of a device; in response to the command, identifying an image associated with a gaze of the user; and identifying an action based on an application of a model to the command and the image, the application of the model including an identification, in the image, of an object for the command; and initiating the action.

In some aspects, the techniques described herein relate to a computing apparatus including: a computer-readable storage medium; at least one processor operatively coupled to the computer-readable storage medium; and program instructions stored on the computer-readable storage medium that, when executed by the at least one processor, direct the computing apparatus to: identify a command from a user of a device; in response to the command, identify an image associated with a gaze of the user; identify an action based on an application of a model to the command and the image, the application of the model including an identification, in the image, of an object for the command; and initiate the action.

In some aspects, the techniques described herein relate to a computer-readable storage medium storing program instructions that when executed by at least one processor cause the at least one processor to execute operations, the operations including: identifying a command from a user of a device; in response to the command, identifying an image associated with a gaze of the user; identifying an action based on an application of a model to the command and the image, the application of the model including an identification, in the image, of an object for the command; and initiating the action.

The details of one or more implementations are outlined in the accompanying drawings and the description below. Other features will be apparent from the description and drawings and the claims.

### BRIEF DESCRIPTION OF THE DRAWINGS

FIG. 1 illustrates a system for managing application actions on a device according to an implementation.

FIG. 2 illustrates a method of operating a device to provide an application action based on a command according to an implementation.

FIG. 3 illustrates an operational scenario of processing a command to implement an action according to an implementation.

FIG. 4 illustrates a timing diagram for implementing an action based on a command according to an implementation.

FIG. 5 illustrates an operational scenario of processing a command to implement an action according to an implementation.

FIG. 6 illustrates an operational scenario of processing a command to implement an action according to an implementation.

FIG. 7 illustrates an operational scenario of processing a command and an image to implement an action according to an implementation.

FIG. 8 illustrates a computing system to process a command and an image to identify an action according to an implementation.

### DETAILED DESCRIPTION

Computing devices, such as wearable devices and extended reality (XR) devices, provide users with an effective tool for gaming, training, education, healthcare, and more. An XR device merges the physical and virtual worlds, encompassing virtual reality (VR), augmented reality (AR), and mixed reality (MR) experiences. These devices usually include headsets or glasses equipped with sensors, cameras, and displays that track user movements and surroundings, allowing them to interact with digital content in real time. XR devices offer immersive experiences by either completely replacing the real world with a virtual one (VR), overlaying digital information onto the real world (AR), or seamlessly integrating digital and physical elements (MR). Input to XR devices may be provided through a combination of physical gestures, voice commands, controllers, and eye movements. Users interact with the virtual environment by manipulating objects, navigating menus, and triggering actions using these input methods, which are translated by the device's sensors and algorithms into corresponding digital interactions within the XR space. However, a technical problem exists in initiating actions with verbal commands that include vague language, including demonstrative pronouns such as commands with terms “this” and “that.”

In at least one technical solution, an XR device may identify a command from a user. The command may comprise a speech command received through a microphone on the device, or a text command received through a keyboard in some examples. The system (i.e., the XR device or other computing apparatus) may identify the command via natural language processing that identifies terms and phrases indicative of a command. For example, a first statement by the user will not be classified as a command, while a second statement or verbal command can be classified as a command. In some implementations, the device can be configured to identify a command based on the user touching a button or providing an explicit term or phrase to indicate a command. For example, the user may provide an explicit phrase before the command to indicate to the device that a command will be following.

In addition to the command, the device can also be configured to identify context via an image or other sensor data. In at least one example, the device may identify an image associated with the gaze of the user (e.g., an image from a camera that reflects the gaze or view of the user). For example, identifying the image associated with the gaze of the user may comprise (or consist of) selecting an image of a camera (e.g., of the XR device or other computing apparatus) having a field of view that covers the direction of gaze of the user, e.g., at the time of the identification of the command or within a predetermined period thereafter. From the image, the device can be configured to identify an action (e.g., selecting an action of a set of predetermined actions) based on an application of a model to the command and the image, the application of the model including an identification, in the image, of an object for the command. An object can be any physical or virtual element in the field of view. The action can include one or more application programming interface operations that interact with at least one application (e.g., a computer program) to implement the user's intent. Once the action is identified, the device can be configured to implement the identified action. Identifying the action based on the application of the model to the command and the image may comprise providing the command and the image as inputs to the model, executing the model with these inputs, and/or obtaining, as an output of the model, the action.

In at least one technical solution, an XR device may identify a command from a user, such as a command to “play my most recent video on that wall.” In response to the command, the XR device will use a model to identify the video to be played (e.g., content) and the wall referenced by the user (e.g., an object in the image). In some examples, the model can represent (or comprise) a language model (e.g., a large language model, LLM). A language mode is an example of a machine learning model designed to understand and work with the human language. The model learns from text data, capturing the nuances, syntax, and semantics of language to predict a desired action of the user. Here, in addition to using the voice command provided by the user, the XR device may use cameras (or other sensors) to provide context in association with vague language elements in the voice command. In at least one implementation, the XR device may capture an image from a camera on the device to identify additional context associated with the user command. For example, when the user references a wall, the device may use an image captured from a camera on the device to identify the referenced wall. The device can further be configured to determine different perception characteristics, including the size, proximity, direction, and the like associated with the related object.

In some technical solutions, the model may request the context information using at least one application programming interface (API). An API is a set of rules and protocols that allows different software applications to communicate with each other. It defines the methods and data structures that may be used to interact with a particular software component, service, or resource. As an example, when a user provides a command, such as a command to display a movie on a wall, one or more APIs may be invoked to identify perception characteristics or three-dimensional characteristics associated with the user's environment. The APIs may be used to identify the location of the wall and initiate the display of the identified video on the wall. Advantageously, based on the user command, the device may identify additional context using one or more APIs to provide the desired action (i.e., the display of the video in the desired location). Some examples of APIs that may be used by the device include graphics APIs that are used to render three-dimensional environments and visual effects, sensor APIs (such as those for accelerometers, gyroscopes, and cameras) to track motion and spatial orientation, or some other API. The technical effect of using the APIs with the language model permits additional sensor data to supplement the command provided by the user and provide a higher-quality action from the command.

In some implementations, the model includes a neural network to support the functionality described herein. A neural network can combine natural language processing with computer vision functionality. In some implementations, the neural network, which can be referred to as a multimodal model, processes both verbal (or text) commands and visual inputs to understand the context and determine desired actions. The natural language processing component of the model interprets the verbal command by parsing the syntax and semantics to identify the user intent. Concurrently, the computer vision component or context component analyzes the captured image to identify relevant objects, their positions, and other contextual details within the physical environment. In some examples, the computer vision component can refine processing by using a gaze or gesture of the user to select only relevant objects associated with the gaze or gesture (e.g., objects viewable in the user's gaze). The neural network then merges the vision information with the natural language processing to determine an action from the command. The neural network may consist of interconnected layers of artificial neurons that allow the model to learn from large amounts of textual data. These networks can include multiple layers such as input, hidden, and output layers. The input layer receives text data (e.g., speech-to-text) and image context information (e.g., object identification, position, etc.), which is then transformed and processed through several hidden layers where complex patterns and relationships within the text and image are learned. The final output layer generates an action or actions based on the learned patterns. The neural network adjusts its weights and biases during training to minimize errors and improve performance, using techniques like backpropagation and gradient descent. The model can be trained using a large knowledge base of user commands associated with different physical environments. The model can be trained for a single user (e.g., environment and commands from the user) or can be trained using multiple users.

In some implementations, a system can be configured to use alternatives to language models or large language models. These alternatives may include rule-based systems, statistical methods, other machine learning models, or some other model. A rule-based system can be configured to use predefined rules to process information and make decisions. These systems are built on a foundation of “if-then” statements, where each rule specifies a condition and an action to be taken if that condition is met. For example, if a first set of words are chosen in a command, then the device can be configured to take a particular action. Statistical methods involve the use of mathematical models and probability theory to analyze and infer patterns from data. In natural language processing, these methods predict linguistic phenomena based on the statistical properties of large text corpora, such as using n-grams to forecast the likelihood of word sequences or to predict the action associated with word sequences. Although these are examples of models, other types of models can be used to determine an action based on a user's intent derived from natural language, gestures, and image context.

Various embodiments of the present technology provide for a wide range of technical effects, advantages, and/or technical solutions for computing systems and components. For example, various implementations may include one or more of the following technical effects, advantages, and/or improvements: 1) non-routine and unconventional use of sensor data to supplement commands from a user; 2) non-routine and unconventional operations to capture image data of an environment and use the image data to support an action determined from a command; 3) improving the human-machine interface to reduce the number of actions performed by a user to implement the user's intent; and 4) non-routine and unconventional use of gesture or gaze information to identify context in an image associated with a command. Thereby, a more natural interaction of the user with the device can be provided, even if the device has a small form factor, such as a head-mounted display (HMD) device and/or lacks external input devices, such as a keyboard, touchscreen or the like.

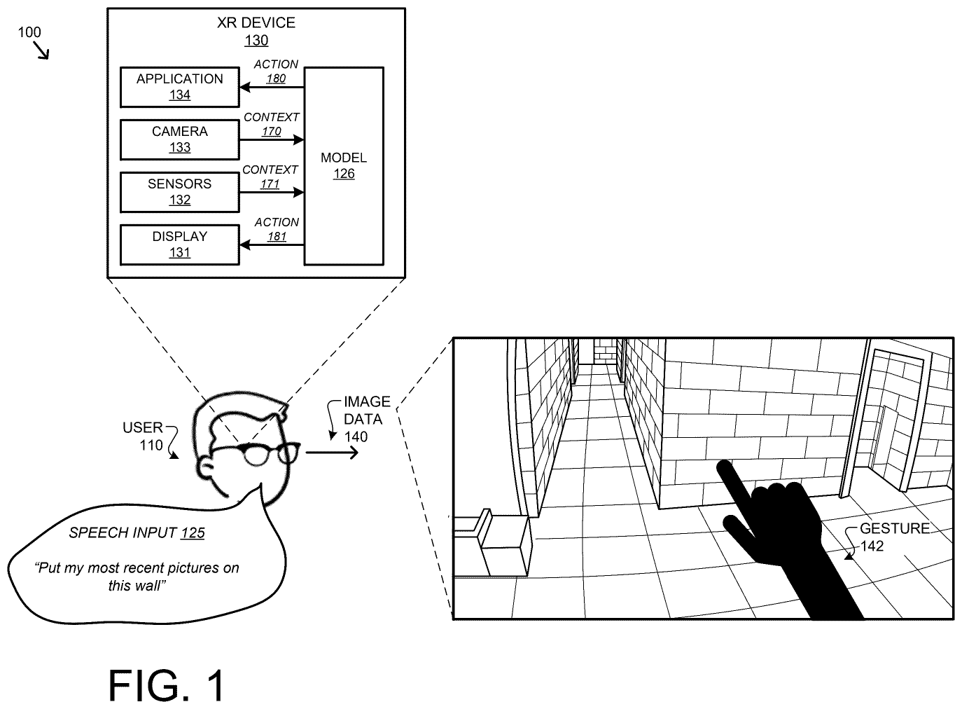

FIG. 1 illustrates a system 100 for managing application actions on a device according to an implementation. System 100 includes XR device 130 and may further include user 110, speech input 125, and image data 140. XR device 130 includes display 131, sensors 132, camera 133, application 134, and model 126. XR device 130 may further provide action 180, action 181, context 170, and context 171. Image data 140 further includes gesture 142, where image data 140 is captured using camera 133. Although demonstrated as an XR device in the example of system 100, other wearable devices may perform similar functionality.

XR device 130 includes a combination of hardware and software components designed to create immersive virtual, augmented, or mixed-reality experiences. Hardware elements include display 131, sensors 132, and camera 133. Display 131 may be a screen or projection system to present immersive visual experiences by rendering three-dimensional graphics and interactive content for visual output. Sensors 132 may include accelerometers and gyroscopes for tracking movement, microphones for capturing voice commands or other audio, depth sensors for spatial awareness and environment mapping, or some other type of sensor. Camera 133 may be used to provide environment mapping, provide spatial tracking, and enable augmented reality experiences for user 110. Camera 133 may represent an outward-facing camera that points away from the user, capturing the surrounding environment to enable features such as augmented reality overlays, spatial mapping, and environment tracking.

In system 100, user 110 generates speech input 125 that is captured by XR device 130 using sensors 132. In response to speech input 125, which is an example of a command, model 126 processes speech input 125 to determine an action associated with the command. However, a technical problem exists when user 110 provides a command with vague terminology. Here, as a technical solution, model 126 supplements the command from speech input 125 with information from sensors 132 and/or camera 133. In at least one implementation, model 126 acts as a language model to obtain and process the additional image and sensor data to implement the user's desired action. When speech input 125 is identified, model 126 processes speech input 125 and generates a representation of its meaning. The representation of its meaning is supplemented by retrieval of additional information from sensors or a captured image (e.g., identify an object, such as a wall or table, referenced by the user). This representation is then used to identify the user's intent and extract relevant information. Based on this understanding, model 126 can perform various tasks or actions such as providing information, scheduling appointments, configuring a display, setting reminders, sending messages, controlling smart home devices, or providing some other action (action 180 or action 181) in association with an application 134 or display 131. In some examples, the tasks or actions may also include audio feedback for the user.

In at least one implementation, speech input 125 is directed at displaying content overlaid on a wall in the real-world environment (an example of mixed reality). For example, the content includes graphics that are overlaid over a respective portion of one or more camera images of the real-world environment that depicts the wall (or other object indicated in the command). Model 126 identifies the content requested by the user and identifies the location of the referenced wall (or other object) using image data 140. Here, model 126 may use one or more APIs to identify the wall (or other object) indicated by user 110. An API may be used to identify one or more gestures of the user (e.g., pointing to a wall or other object), may be used to identify wall characteristics in image data 140 (e.g., size, proximity, etc.), or may be used to provide some other functionality associated with the perception or three-dimensional environment for the user. In some examples, the API may further be used to identify and manage content associated with applications. The API may be used to start an application, identify images, video, or another data file (e.g., stored in a memory of the XR device or another device communicatively coupled therewith), send a message, or perform some other action in association with an application or display. In the example of speech input 125, model 126 identifies the wall (or other object) referenced by user 110 based on image data 140 and gesture 142. Once identified, model 126 identifies the desired content for the user based on speech input 125 and displays the content on the identified wall. In some implementations, model 126 may identify a depth, a distance, a direction, a size, or some other feature associated with the wall (or other object). From the identified features, the identified content can be overlaid on display 131 to appear on the identified wall. The technical effect is a mixed reality appearance of the content with the physical environment for user 110.

Although demonstrated in the example of system 100 as providing content for display on XR device 130, similar operations can be performed to provide a variety of different actions. XR device 130 and model 126 may use perspective information derived from cameras and/or infrared (IR) sensors to identify various information about the physical environment. The information may include depth, distance, direction, size, or some other information associated with the physical environment. In some examples, the information is derived via API calls that identify supplemental information associated with the speech input from user 110. The actions may be used to provide information, schedule appointments, set reminders, send messages, control smart home devices, or provide some other action in association with an application or display 131. The action provided may comprise at least one API command to provide the user's desired intent. The at least one API command may directly display content or interact with one or more other applications to provide the desired intent. In some examples, the at least one API command can be configured to provide audio feedback associated with the user intent.

In some implementations, the device and model may use gesture 142 and/or the gaze of the user to select a portion of the image that is most relevant to the query. For example, when a gesture is available and identified via the sensors (e.g., the user pointing at an object), the device may restrict the image processing to a portion of the image associated with the gesture (e.g., at which the gesture points and/or which is identified by the gesture). Alternatively, when a gesture is unavailable, the device may monitor the gaze of the user and restrict the image processing to a portion of the image associated with the gaze. Gaze may be tracked using a combination of infrared sensors and cameras that monitor the position and movement of the user's eyes to determine where they are looking. A device can also be configured to track the user's gaze using accelerometers or gyroscopes that monitor the movement of the user's head (and/or by another gaze-tracking system).

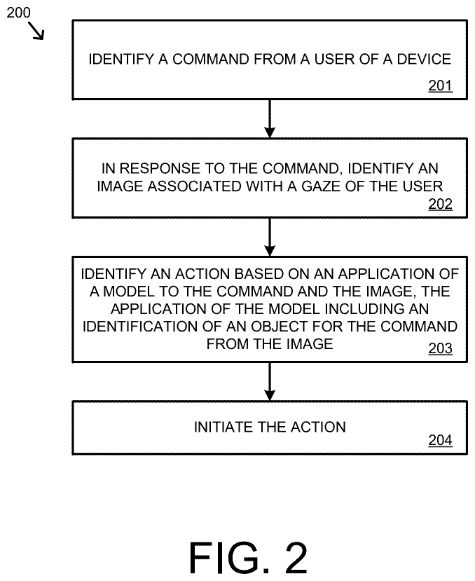

FIG. 2 illustrates a method 200 of operating a device to provide an application action based on a command according to an implementation. Method 200 may be performed by XR device 130 in some examples, however, method 200 may be performed by any wearable device including AR devices, XR devices, or some other device. Method 200 is described below with reference to elements of system 100 of FIG. 1.

Method 200 includes identifying a command from a user of a device at step 201. In some implementations, the command comprises speech input. In other implementations, the command may comprise a typed command or a touch command. In response to the command, method 200 further includes identifying an image associated with a gaze or gesture of the user at step 202. Method 200 also includes identifying an action based on an application of a model to the command and the image, the application of the model including an identification of an object for the command in the image at step 203. Once identified, method 200 further includes initiating the action in association with the object at step 204.

In some implementations, a command provided by a user will include vague or ambiguous terms (e.g., “this” or “that”). In response to the command, the device may apply a model to the command to determine the supplemental context required to act on the command. A command may comprise a voice or typed command that can be identified from the natural language of the input from the user. Accordingly, while a first input from the user may not be identified as a command, a second input from the user may be identified as a command based on the word or phrase choice associated with the input (including an express trigger word). For example, user 110 provides speech input 125 that includes at least one ambiguous term. Model 126 processes speech input 125 to trigger one or more API requests that identify context 170 or context 171. In at least one implementation, model 126 represents a language model that processes the text associated with speech input 125. A language model may work by understanding human language through algorithms trained on text data. These models are trained to predict and generate text by learning patterns from diverse datasets. During an inference phase, the model processes user inputs using natural language processing techniques to understand context and intent. Model 126 leverages natural language processing by integrating with other services and APIs to fetch information or perform actions requested by users. Here, in addition to using the text provided by the user, model 126 supplements speech input 125 with context identified from one or more other sensors or cameras, such as sensors 132 and camera 133. In at least one example, the context retrieved is based on the language included in the command. For example, when the user states “on this wall” as part of speech input 125, model 126 may identify the ambiguous term and use one or more APIs to retrieve context information about the wall. Once the additional context information is obtained, model 126 identifies an action associated with the command and initiates the action in association with an object identified as part of the context information (e.g., referenced wall, chair, or some other physical object identifiable from an image on the device). In some implementations, the model may further use gesture or gaze information to select the object relevant to the user command.

Using the example in system 100, model 126 may open the most recent pictures from a photo application available on XR device 130 and orient the presentation of the photo application on the wall. In at least one example, model 126 may identify the orientation, including size, location, and the like, of the content displayed on the wall based on features (e.g., depth, distance, direction, or size) associated with the wall. The orientation for the application, or application window, may refer to its layout and positioning on the screen, including whether it is in portrait (taller than wide) or landscape (wider than tall) mode. It may encompass the application window size, aspect ratio, and position on the screen, such as centered or aligned to a corner. The orientation may be calculated such that the application window is overlaid on the object using display 131. In this manner, user 110 views the application as though the application window is located on the wall (or some other desired location).

In at least one example, model 126 may be representative of a transformer language model. A transformer language model is a type of artificial intelligence model used for natural language processing tasks. It leverages self-attention mechanisms to process and generate text, allowing it to understand the context of each word in a sentence by considering its relationships with all other words simultaneously. Additionally, the transformer language model may incorporate other information captured from cameras and sensors to provide context in association with the natural language. The technical effect permits model 126 to capture complex dependencies and patterns in the data (language, image, and sensor) to provide an action associated with the user command.

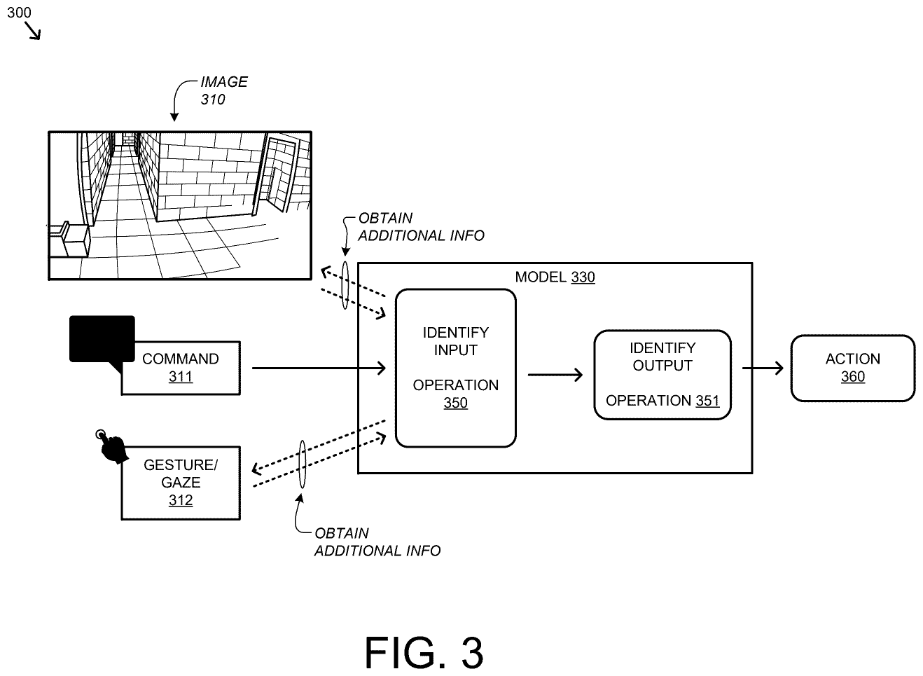

FIG. 3 illustrates an operational scenario 300 of processing a command to implement an action according to an implementation. Operational scenario 300 includes image 310, command 311, gesture/gaze 312, model 330, and action 360. Model 330 provides operation 350 and operation 351. Model 330 may be implemented on a wearable device, such as an XR device in some examples.

In operational scenario 300, model 330 identifies inputs associated with command 311 using operation 350. In at least one implementation, operation 350 identifies command 311 from a microphone, keyboard, or some other input device. For example, a user of an XR device may generate a command to purchase an object. In response to receiving the command, model 330 and operation 350 determine additional context required to support the request. The additional context may be gathered through one or more cameras or other sensors using APIs that identify the relevant context. For example, operation 350 may obtain image 310 or traits associated with image 310 using one or more API commands. The API commands may be used to identify a particular object and identify a depth, a distance, a direction, or a size associated with the object.

Additionally, operation 350 may use one or more APIs to determine the object referenced by the user in association with command 311, where the APIs may identify gaze/gesture 312. For example, operation 350 may determine whether the user performs a gesture relating to an ambiguous term in command 311 (e.g., reference to a wall, table, or other physical object in the environment). A gesture involves using hand movements or body gestures to interact with or control the virtual environment. Examples of gestures for an XR device may include swiping to scroll, pinching to zoom, tapping to select, grabbing to move objects, and pointing to navigate. Gestures may be identified using a combination of sensor data (such as cameras, accelerometers, and gyroscopes) and algorithms that process and interpret the movement and positioning of the user's hands and fingers. Using a gesture from the user (e.g., tap to select), operation 350 may more accurately identify the desired object in image 310. Alternatively, when a gesture is not identified, in association with the command, operation 350 may determine information about the gaze of the user to identify an object in the physical environment. Gaze may be determined using eye-tracking technology, which typically involves infrared sensors and cameras that capture the position and movement of the user's eyes. This data is processed to compute the direction of the user's gaze, enabling the device to understand where the user is looking within the physical environment. In some examples, the gaze may be determined using one or more additional sensors, such as accelerometers or gyroscopes, that monitor the position of the user's head relative to the environment. From the gaze information, operation 350 may more accurately identify objects referenced by the user in image 310. In at least one example, a vector for the gaze may be applied to image 310 to identify an object or objects that are within the focus of the user's gaze. Further, when multiple objects are within the same field of view, the gaze focus may be used to select the appropriate object based on the user command. An example may be a user command to add a particular chair to a shopping cart from a set of available chairs.

Once the inputs are identified, model 330 further performs operation 351 which identifies action 360. In some implementations, operation 351 implements a language model to identify action 360. The language model processes the input to identify the user's intent, analyzing both the content of command 311 and context from image 310 and gesture/gaze 312. Once the intent is determined, the virtual assistant may determine the appropriate action, which may include interacting with other applications, fetching information, opening an application for display, or executing commands directly in the XR environment. This decision is implemented by calling relevant APIs or utilizing other device features, such as overlaying information in augmented reality. The assistant may provide feedback or results directly in the user's field of view, creating an interactive and immersive experience. The assistant may, in addition to or in place of providing feedback via the display, provide feedback via audio.

In some implementations, action 360 may include displaying content for the user of the device. Operation 351 will identify the required content from the identified inputs of operation 350 and will further identify an orientation of the content based at least on the characteristics derived from image 310. For example, if the command requests content to be displayed on a wall of the physical environment, operation 351 will identify the requested content (either from local storage or from remote storage) and determine how to present the content per the command. Operation 351 may identify features of the wall (or other object) including a depth, a distance, a direction, or a size of the wall. From the features, an anchor can be established on the display of the device, such that the content can be overlaid as though the content is on the wall.

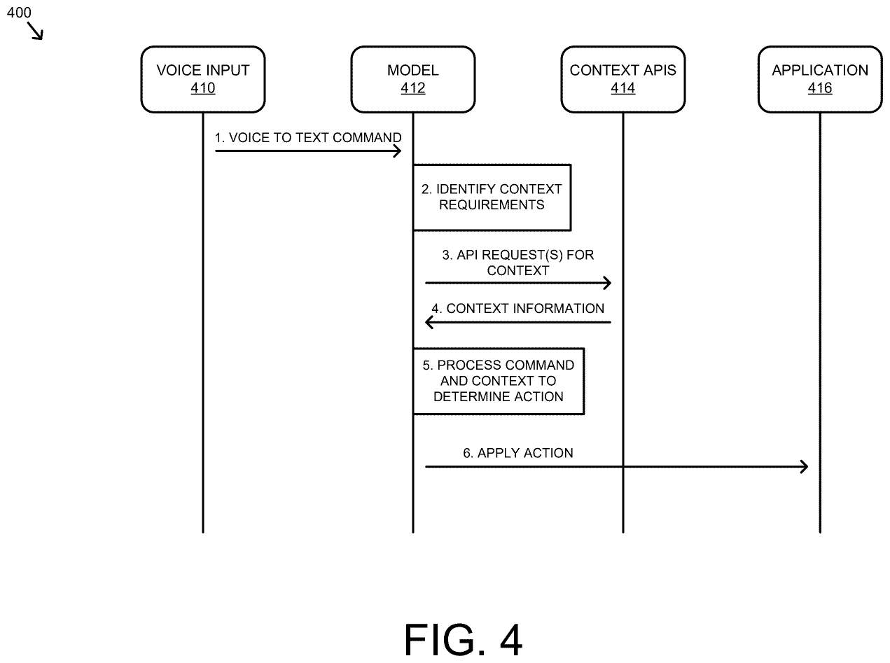

FIG. 4 illustrates a timing diagram 400 for implementing an action based on a command according to an implementation. Timing diagram 400 includes voice input 410, model 412, context APIs, and application 416. Timing diagram 400 is representative of an operation that can be performed by XR device 130 of FIG. 1 or some other wearable device.

At step 1, model 412 receives voice input 410 as voice-to-text. The voice input can be identified passively by words or phrases associated with a command or can be identified using a command phrase, button, or other trigger element. In response to receiving voice input, model 412 identifies context requirements associated with ambiguous terms within the command at step 2. The context requirements may include identifying context using at least one sensor or camera on the device. For example, an external-facing camera on an XR device may identify at least one object referenced in the command from the user. To support the context requirements, model 412 may generate API requests to obtain the relevant context at step 3. Context APIs 414 are configured to return context information associated with the requests at step 4. The API requests can be used to identify objects associated with the command, the size of the objects associated with the command, the distance or depth of the objects associated with the command, the directionality of objects associated with the command, or some other information associated with objects referenced in the command. For example, if the user references a chair (or other object) an API can be used to perform object recognition on an image from an outward-facing camera to identify the object (e.g., chair) associated with the request. In some implementations, the API requests can be used to obtain information associated with the user gaze or gestures. User gaze on an XR device refers to the tracking and interpretation of where a user is looking within the virtual or augmented environment to understand their focus and intent. A user gesture on an XR device is a physical movement or hand sign recognized by the device to interact with and control the virtual or augmented environment. For example, the XR device can be configured to perform an API request to determine whether the user is pointing in a particular direction to determine whether the point intersects a relevant object captured in the image from the outward-facing camera. Model 412 can be configured to identify the API requests required based on the command, previous user interactions with model 412, or previously implemented API requests. For example, a first API request from model 412 may determine a gesture for the user (e.g., the user is pointing). A second API request from model 412 can then be used to identify characteristics associated with an object that corresponds to or intersects the pointing vector from the user. Any number of API requests to different applications or services may be used to provide context for voice input 410.

After context information is received from context APIs 414, model 412 is configured to process the command and the context information to determine an action at step 5. In some implementations, model 412 provides a language model that uses language from the command with the context from the APIs to derive the action. In some examples, model 412 identifies intent for the command by analyzing the language and contextual information, such as the user's previous interactions, preferences, and the current environment detected via context APIs 414 (and the corresponding sensors) to provide a more accurate action determination.

Once the intent of the command is established, model 412 initiates the identified action at step 6. In some implementations, model 412 can be configured to execute actions such as environmental interaction with virtual objects, displaying information overlays like weather updates or media content, providing navigation through spaces, controlling applications such as web browsers, facilitating content creation, or some other action. In implementing the action, model 412 can be configured to apply one or more APIs to provide the desired action. These can be used to open the application, configure the display of the application, select content within the application, or provide some other action in association with the application.

As an illustrative example, a command from a user may indicate content and a location for the content relative to the user environment. Model 412 can be configured to select or identify the relevant content and the orientation of the content to support the command using at least the text of the command itself and context information derived at least partially from an image of the user's environment.

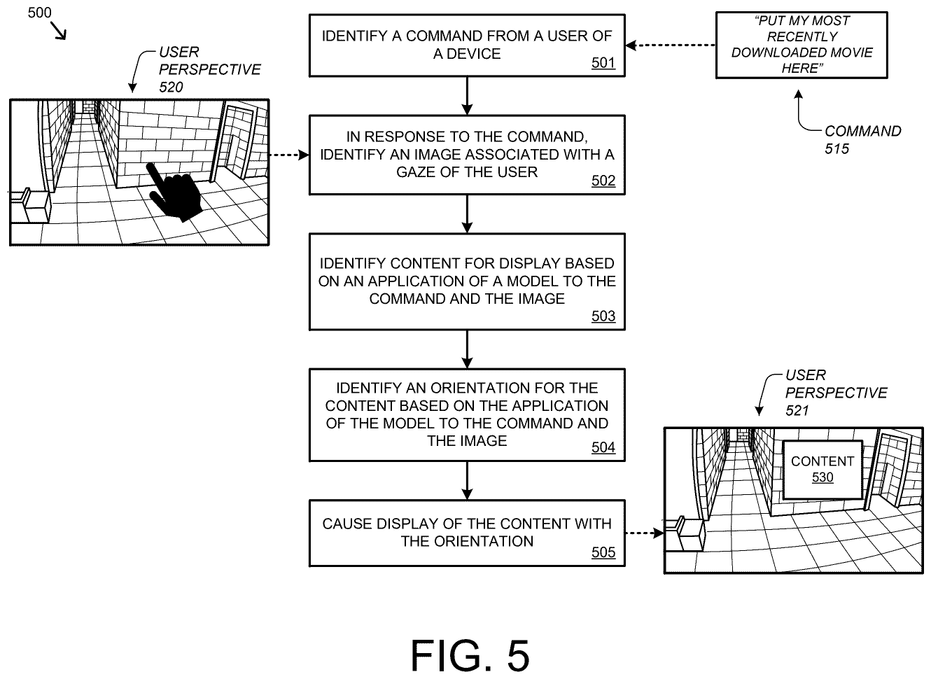

FIG. 5 illustrates an operational scenario 500 of processing a command to implement an action according to an implementation. Operational scenario 500 includes command 515, steps 501-505, user perspective 520, and user perspective 521. Steps 501-505 of operational scenario 500 may be performed by a wearable device, such as an XR device in some examples.

In operational scenario 500, a device identifies a command 515 at step 501. The command can be provided as a voice command, as a typed command, or as some other user command. In response to the command, the device identifies an image associated with the gaze of the user at step 502. In some implementations, the device may be configured with an outward-facing camera, the outward-facing camera positioned to capture the surrounding environment external to the user. It enables the device to perceive and understand the real-world environment by capturing images or video footage of the user's surroundings. In the example of an XR device, the camera may be positioned to capture the environment like the user's perspective by mounting the camera in a similar position to the gaze of the user. User perspective 520 is representative of the user's perspective from the device.

Once the image is identified, operational scenario 500 further identifies content for display based on an application of a model to the command and the image at step 503 and identifies an orientation for the content based on the application of the model to the command and the image at step 504. In some implementations, the model represents a language model that performs actions by first interpreting user commands or inputs through natural language processing. This involves converting spoken words or text into a format the language model can understand, breaking down the input into understandable components, and determining the user's intent. The language model further breaks down contextual inputs, associated with at least the identified image to derive the desired action. In breaking down the inputs including the command and the contextual information (e.g., sensor-derived information), the model can generate tokens, which may comprise words or segments of the words from the command, image traits, or descriptors of objects identified in the image, or some other text-based information. The tokens are then processed by the model and the model's algorithms to determine the intent of the user and a corresponding action. These algorithms can be trained on data across a set of users or the individual user that correlates actions to commands and environmental context, such as information derived from the image of the environment.

In the example of operational scenario 500, the model determines that the user command intends to generate a display of content 530 on a wall identified in association with user perspective 520 (i.e., user gaze). In some implementations, the device will identify and use the user's gaze to determine the selected wall. The device may be configured to identify a gaze vector (i.e., direction) associated with the user's eyes and/or head and determine an intersection with the identified wall. The gaze vector may be determined using eye tracking sensors, such as IR sensors or cameras, may be determined based on accelerometers and gyros, or may be determined by some other combination of sensors and software. Intersecting objects with the gaze vector may be used in association with providing the action for the command. In other implementations, the device may be configured to identify a user gesture in the image from the outward-facing cameras to select the intended wall for the user. The device may be configured to determine a vector or ray associated with the gesture and follow the ray to identify an intersecting item. In some examples, a gesture ray cast is a computational technique to project a virtual ray from a user's hand, finger, or other extremity to determine which objects it intersects. In still other examples, the device may select the wall based on a combination of the user gaze and the hand. For example, the device may be configured to average the gaze ray cast and the gesture ray cast to determine an object referenced by the user.

Once the intent of the user is determined based on the command and features (i.e., objects) identified in the image, the model in operational scenario 500 causes display of the content with the orientation at step 505. The display changes the user's perspective from user perspective 520 to user perspective 521 with content 530 displayed on the identified wall. In some implementations, when processing the image data from the camera, the device can determine features associated with displaying the content in the orientation desired by the user. In at least one implementation, the model of the device can determine size, distance, depth, length, or some other physical property about the user-referenced wall. From the information, the model can be configured to initiate one or more API operations or requests that display the content overlaid on the wall, such that the content appears as though it is being displayed on the wall. At least one technical effect is that the content is provided as an augmented reality presentation to the user and overlaid onto the physical environment.

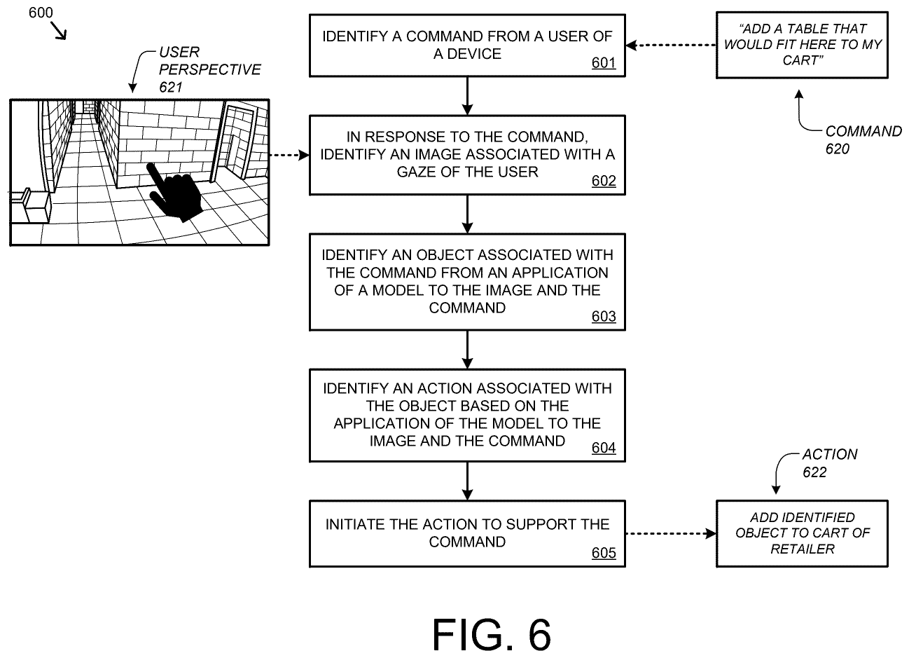

FIG. 6 illustrates an operational scenario 600 of processing a command to implement an action according to an implementation. Operational scenario 600 includes operations 601-605, command 620, user perspective 621, and action 622. Operational scenario 600 can be performed by an XR device or some other wearable device.

Operational scenario 600 includes identifying a command 620 from a user of the device at step 601. In response to the command, operational scenario 600 identifies an image associated with the gaze of the user at step 602 and identifies an object associated with the command from an application of a model to the image and the command at step 603. In some examples, the device can be configured with an outward-facing camera that captures the environment from the user perspective 621. In some implementations, the model is representative of a language model capable of identifying intent from the text of the command (i.e., speech-to-text) and contextual information gathered from the image. In the example of operational scenario 600, the model can be configured to identify intent from the language in command 620, wherein the intent indicates that an object should be added to the cart. The model can further be configured to determine a table from a retailer or retailers that fits the space in the physical area captured as part of the image (and indicated through gaze or gesture). In some implementations, the table can be identified via a search of one or more retailers, wherein the retailers can be a preference of the user, a default retailer associated with the device, a current application open on the device, or some other selection of retailers.

In some implementations, the system may use APIs or other functions that identify objects and characteristics of the objects, including depth, distance, direction, size, or some other characteristic of the objects. Using the table example, the model can be configured to determine the floor space available using the image and/or additional sensors that identify the depth and size of an area captured by the device in association with the user perspective 621.

Once the intent is determined, operational scenario 600 identifies an action associated with the object based on the application of the model to the image and the command at step 604 and initiates the action to support the command at step 605. In some examples, the model may identify one or more APIs or other functions to implement the action. Here, to implement action 622, the model may generate an API request to add an identified table to the user's cart in an application. In some examples, the model may be configured to search the retailer application for tables with the size features determined from the image of the user environment. From the different possibilities, the model can be configured to provide an API request to the retailer application to add a table to the cart (e.g., a table that fits the dimensions). The model can also consider other factors, such as user preferences (e.g., design or cost preferences), ratings associated with the available tables, or other information that permits the model to select the action.

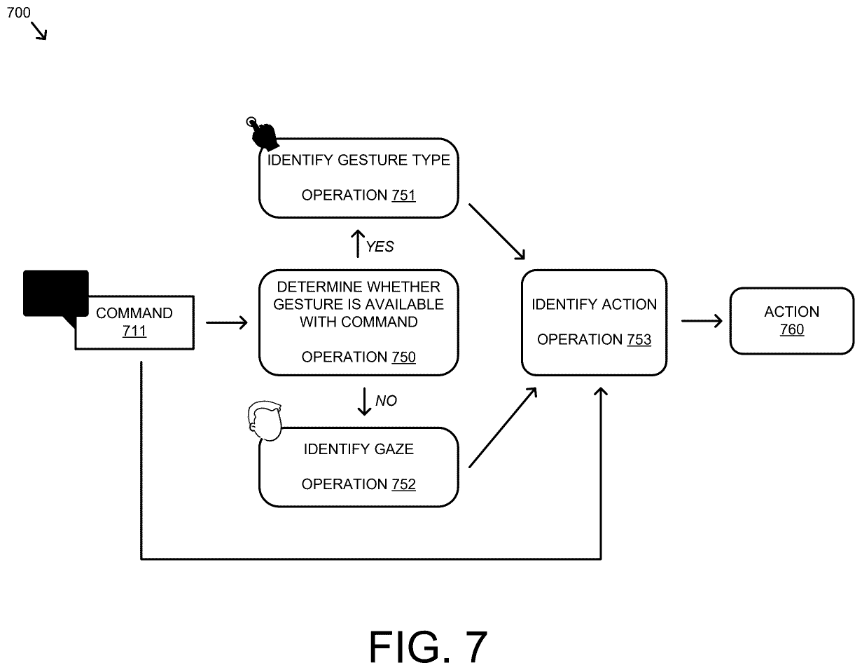

FIG. 7 illustrates an operational scenario 700 of processing a command and an image to implement an action according to an implementation. Operational scenario 700 includes command 711, operations 750-753, and action 760. Operations 750-753 may be performed by a model executing on an XR device or some other device.

In operational scenario 700, command 711 is provided by a user of a device. In response to the command, operation 750 is performed which determines whether a gesture is available with the command. A gesture is a physical movement or motion, such as a hand wave or finger tap, that the device recognizes and interprets as a specific command or action. A gesture may be identified by a camera (e.g., an outward-facing camera) or may be identified by other sensors, such as IR or depth sensors. When a gesture is available, operational scenario 700 may identify a gesture type a physical object that intersects the gesture ray cast at step 751 and moves to operation 753.

When a gesture is unavailable, operation 752 is performed to identify a gaze associated with the user for command 711. The gaze can be identified by using eye-tracking (or head position) technology, which typically involves a combination of infrared sensors and cameras. These sensors and cameras track the position and movement of the user's eyes, capturing data on where the user is looking in the physical environment. The device processes this data to determine the direction and focus of the gaze (i.e., the intersection point of the gaze with an object). Once the gaze is identified, operational scenario 700 moves to operation 753. In some examples, the gesture or gaze information will be used by the model when the command requires it. For example, a command that does not require information about the physical environment may not require information about the gesture or gaze of the user to provide the desired action.

Once the object or objects are identified from the gesture or gaze, operation 753 is performed which identifies an action for command 711. In some implementations, operation 753 applies a model or language model to identify action 760. The language model processes command 711 in text form to understand the intent and context. Simultaneously, computer vision algorithms, such as APIs analyze images of the environment to identify relevant objects, spatial relationships, and contextual cues. Here, the computer vision algorithms may identify the objects (and contextual information about the objects) that intersect the user's gesture or gaze. The technical effect limits the processing of the image to a portion of the objects in the physical environment. The integration of these two data streams allows the model to form a comprehensive understanding of the situation for the user. For example, if the command is “order this cereal again,” the model must recognize the keyword “cereal” and identify the cercal based on the image and the gesture or gaze. This involves both semantic understanding of the command and visual recognition of objects.

The model then determines the appropriate action by mapping the interpreted command to a specific function or sequence of functions. This decision-making process involves both rule-based algorithms and machine learning models trained on datasets to predict the best course of action. The model can use predefined rules to handle straightforward commands or leverage deep learning techniques to make more complex decisions based on the context provided by both the verbal command and the visual environment. By combining linguistic and visual information, the language model ensures that the action taken is accurate and contextually appropriate, enhancing the device's responsiveness and functionality. For example, after identifying the cereal or cereal box, the device can purchase the cereal using a web browser or retail application on the device.

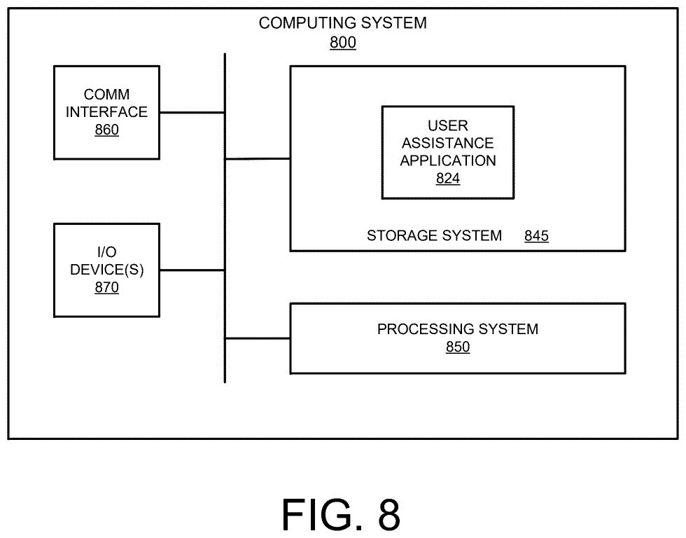

FIG. 8 illustrates a computing system 800 to process a command and an image to identify an action according to an implementation. Computing system 800 is representative of any computing device or devices with which the various operational architectures, processes, scenarios, and sequences disclosed herein for initiating application actions based on a model may be implemented. Computing system 800 is an example of an AR device, an MR device, an XR device, or some other wearable device. Computing system 800 includes storage system 845, processing system 850, communication interface 860, and input/output (I/O) device(s) 870. Processing system 850 is operatively linked to communication interface 860, I/O device(s) 870, and storage system 845. Communication interface 860 and/or I/O device(s) 870 may be communicatively linked to storage system 845 in some implementations. Computing system 800 may further include other components such as a battery and enclosure that are not shown for clarity.

Communication interface 860 comprises components that communicate over communication links, such as network cards, ports, radio frequency, processing circuitry with software, or some other communication devices. Communication interface 860 may be configured to communicate over metallic, wireless, or optical links. Communication interface 860 may be configured to use Time Division Multiplex (TDM), Internet Protocol (IP), Ethernet, optical networking, wireless protocols, communication signaling, or some other communication format—including combinations thereof. Communication interface 860 may be configured to communicate with external devices, such as servers, user devices, or some other computing device.

I/O device(s) 870 may include peripherals of a computer that facilitate the interaction between the user and computing system 800. Examples of I/O device(s) 870 may include keyboards, mice, trackpads, monitors, displays, printers, cameras, microphones, external storage devices, sensors, and the like. In some implementations, one or more cameras may be used to capture images associated with an outward view from the computing device. The outward-facing cameras may enable augmented reality experiences, spatial mapping, and enhanced user interaction with the physical world.

Processing system 850 comprises microprocessor circuitry (e.g., at least one processor) and other circuitry that retrieves and executes operating software (i.e., program instructions) from storage system 845. Storage system 845 may include volatile and nonvolatile, removable, and non-removable media implemented in any method or technology for storage of information, such as computer-readable instructions, data structures, program modules, or other data. Storage system 845 may be implemented as a single storage device but may also be implemented across multiple storage devices or sub-systems. Storage system 845 may comprise additional elements, such as a controller to read operating software from the storage systems.

Examples of storage media (also referred to as computer-readable storage media) include random access memory, read-only memory, magnetic disks, optical disks, and flash memory, as well as any combination or variation thereof, or any other type of storage media. In some implementations, the storage media may be non-transitory. In some instances, at least a portion of the storage media may be transitory. In no case is the storage media a propagated signal.

Processing system 850 is typically mounted on a circuit board that may also hold the storage system. The operating software of storage system 845 comprises computer programs, firmware, or some other form of machine-readable program instructions. The operating software of storage system 845 comprises user assistance application 824. The operating software on storage system 845 may further include an operating system, utilities, drivers, network interfaces, applications, or some other type of software. When read and executed by processing system 850 the operating software on storage system 845 directs computing system 800 to operate as a computing device as described herein. In at least one implementation, the operating software can provide method 200 described in FIG. 2.

In at least one example, user assistance application 824 directs processing system 850 to identify a command from a user of computing system 800 and, in response to the command, identify an image associated with a gaze of the user. In some implementations, the command may be received via a microphone or keyboard as part of I/O device(s) 870. In some implementations, the image may be captured via an outward-facing camera that enables augmented reality experiences, spatial mapping, and enhanced user interaction with the real world. In some implementations, the outward-facing cameras may capture portions of the physical world associated with the user's gaze.

User assistance application 824 further identifies an action based on an application of a model to the command and the image, the application of the model including an identification of an object for the command in the image. User assistance application 824 may be configured to perform a wide range of actions to enhance a user experience with computing system 800. Actions may include providing contextual information, managing tasks, and controlling smart devices through the commands and contextual information derived from the image. User assistance application 824 may further be configured to facilitate communications through text messages or emails, provide recommendations, play media content such as videos, generate calendar updates, or provide some other action based on the command and contextual information identified from the image.

In some implementations, the model may comprise a language model that initiates an action based on the command and the contextual information derived from the image. The language model implements an action on the device by processing the user's command, interpreting the intent, and then executing the corresponding API operations to deliver the user's intent. For example, if a user command comprises a verbal command to “play my favorite movie on this wall,” the language model may process the text of the command to initiate the playback of the movie. Examples of API operations that facilitate the operation may include one or more spatial API operations to identify the wall based on user gaze or gesture, one or more spatial API operations to identify features of the wall (depth, distance, direction, size, etc.), one or more API operations to identify the user's favorite movie, and one or more API operations to initiate the playback in an orientation for the wall. In at least one example, the playback of the video may be displayed such that it is overlayed on the wall as though it is being displayed on the wall. The overlay of the playback may consider various factors including the depth, distance, direction, and size of the wall determined from the API requests. Additionally, the overlay of the playback may consider the gaze of the user, such that the playback on the screen is displayed by computing system 800 as though the content is on the wall.

Although demonstrated in the previous example as displaying content (i.e., the user's favorite movie), user assistance application 824 may be configured to provide other actions based on spatial API information derived from the environment. The actions may include adding an object to a shopping cart, identifying whether an object (e.g., sofa) will fit in the user's physical environment, or making some other determination based on the spatial characteristics identified using one or more API operations.

In some implementations, user assistance application 824 may be configured to determine physical objects that are referenced by the user in association with the command. In at least one example, user assistance application 824 directs processing system 850 to use a camera or some other type of sensor to determine whether the user is making a gesture toward an object or objects. A gesture may be a physical movement or pose recognized by a camera or sensor as a specific input or command. For example, a gesture can include a pointing motion by the user toward an object. When a gesture is available, the gesture can be used by user assistance application 824 to identify one or more objects associated with the user command. In some examples, the gesture may be used to create a ray or vector based on the sensors that then identify objects that the ray or vector intersects.

In some examples, a gesture may not be identified in association with the command (e.g., a hand, arm, or other extremity is not identified by the sensors). When the gesture is unavailable, user assistance application 824 can be configured to use a gaze, or a vector associated with the user's gaze to identify the object referenced by the user in the command. A gaze vector can be determined by tracking eye movements to determine the direction of the gaze, then projecting this vector into the physical space to identify intersections with one or more physical objects captured by one or more cameras. Computing system 800 can use computer vision algorithms or spatial mapping data to recognize and identify the object at the intersection to support the command. For example, when the user provides a statement of “add this chair to my car,” the system may monitor the gaze of the user and determine whether the gaze intersects a chair in an image captured by the outward-facing camera. The identified chair can then be processed using image recognition software to determine identifying information about the chair (type, manufacturer, and the like) and add the chair to the user's cart.

Clause 1. A method comprising: identifying a command from a user of a device; in response to the command, identifying an image associated with a gaze of the user; identifying an action based on an application of a model to the command and the image, the application of the model including an identification, in the image, of an object for the command; and initiating the action.

Clause 2. The method of clause 1, wherein identifying the action based on the application of the model to the command and the image comprises identifying content for display and an orientation for the content based on the application of the model to the command and the image, and wherein initiating the action comprises causing display of the content in the orientation on the display.

Clause 3. The method of clause 2, wherein identifying the orientation for the content on the display includes identifying a location for the content on the display.

Clause 4. The method of clause 2 or 3, wherein the action overlays the content on the object.

Clause 5. The method of any of clauses 2 to 4, wherein identifying the orientation for the content on the display of the device comprises: identifying a depth, a distance, a direction, or a size of the object in the image; and identifying the orientation based on the depth, the distance, the direction, or the size of the object in the image.

Clause 6. The method of any of clauses 1 to 5, wherein the action includes at least one application programming interface operation for an application.

Clause 7. The method of any of clauses 1 to 6, wherein the application of the model to the command and the image includes: identifying a depth, a distance, a direction, or a size of the object to support the command.

Clause 8. The method of any of clauses 1 to 7 further includes: identifying a gesture; wherein identifying the action is based on the application of the model to the command, the image, and the gesture.

Clause 9. A computing apparatus comprising: a computer-readable storage medium; at least one processor operatively coupled to the computer-readable storage medium; and program instructions stored on the computer-readable storage medium that, when executed by the at least one processor, direct the computing apparatus to: identify a command from a user of a device; in response to the command, identify an image associated with a gaze of the user; identify an action based on an application of a model to the command and the image, the application of the model including an identification, in the image, of an object for the command; and initiate the action.

Clause 10. The computing apparatus of clause 9, wherein identifying the action based on the application of the model to the command and the image comprises identifying content for display and an orientation for the content based on the application of the model to the command and the image, and wherein initiating the action comprises causing display of the content in the orientation on the display.

Clause 11. The computing apparatus of clause 10, wherein identifying the orientation for the content on the display includes identifying a location for the content on the display.

Clause 12. The computing apparatus of clause 10 or 11, wherein the action overlays the content on the object.

Clause 13. The computing apparatus of any of clauses 10 to 12, wherein identifying the orientation for the content on the display of the device comprises: identifying a depth, a distance, a direction, or a size of the object in the image; and identifying the orientation based on the depth, the distance, the direction, or the size of the object in the image.

Clause 14. The computing apparatus of any of clauses 9 to 13, wherein the action includes at least one application programming interface operation for an application.

Clause 15. The computing apparatus of any of clauses 9 to 14, wherein the application of the model to the command and the image includes: identifying a depth, a distance, a direction, or a size of the object to support the command.

Clause 16. The computing apparatus of any of clauses 9 to 15, wherein the program instructions further direct the computing apparatus to: identify a gesture; wherein identifying the action based on the application of the model to the command and the image includes identifying the action based on the application of the model to the command, the image, and the gesture.

Clause 17. A computer-readable storage medium storing program instructions that when executed by at least one processor cause the at least one processor to execute operations, the operations comprising: identifying a command from a user of a device; in response to the command, identifying an image associated with a gaze of the user; identifying an action based on an application of a model to the command and the image, the application of the model including an identification, in the image, of an object for the command; and initiating the action.

Clause 18. The computer-readable storage medium of clause 17, wherein identifying the action based on the application of the model to the command and the image comprises identifying content for display and an orientation for the content based on the application of the model to the command and the image, and wherein initiating the action comprises causing display of the content in the orientation on the display.

Clause 19. The computer-readable storage medium of clause 18, wherein identifying the orientation for the content on the display includes identifying a location for the content on the display.

Clause 20. The computer-readable storage medium of any of clauses 17 to 19, wherein the application of the model to the command and the image includes: identifying a depth, a distance, a direction, or a size of the object to support the command.

In this specification and the appended claims, the singular forms “a,” “an” and “the” do not exclude the plural reference unless the context dictates otherwise. Further, conjunctions such as “and,” “or,” and “and/or” are inclusive unless the context dictates otherwise. For example, “A and/or B” includes A alone, B alone, and A with B. Further, connecting lines or connectors shown in the various figures presented are intended to represent example functional relationships and/or physical or logical couplings between the various elements. Many alternative or additional functional relationships, physical connections, or logical connections may be present in a practical device. Moreover, no item or component is essential to the practice of the implementations disclosed herein unless the element is specifically described as “essential” or “critical.”

Terms such as, but not limited to, approximately, substantially, generally, etc. are used herein to indicate that a precise value or range thereof is not required and need not be specified. As used herein, the terms discussed above will have ready and instant meaning to one of ordinary skill in the art.

Moreover, the use of terms such as up, down, top, bottom, side, end, front, back, etc. herein are used with reference to a currently considered or illustrated orientation. If they are considered with respect to another orientation, such terms must be correspondingly modified.

Further, in this specification and the appended claims, the singular forms “a,” “an” and “the” do not exclude the plural reference unless the context dictates otherwise. Moreover, conjunctions such as “and,” “or,” and “and/or” are inclusive unless the context dictates otherwise. For example, “A and/or B” includes A alone, B alone, and A with B.

Although certain example methods, apparatuses, and articles of manufacture have been described herein, the scope of coverage of this patent is not limited thereto. It is to be understood that the terminology employed herein is to describe aspects and is not intended to be limiting. On the contrary, this patent covers all methods, apparatus, and articles of manufacture fairly falling within the scope of the claims of this patent.

What is claimed is:

1. A method comprising:
identifying a command from a user of a device;
in response to the command, identifying an image associated with a gaze of the user;
identifying an action based on an application of a language model to the command and the image, the application of the language model including an identification, in the image, of an object for the command; and
initiating the action in association with the object.

2. The method of claim 1,
wherein identifying the action based on the application of the language model to the command and the image comprises identifying content for display and an orientation for the content based on the application of the language model to the command and the image, and
wherein initiating the action comprises causing display of the content in the orientation on a display.

3. The method of claim 2, wherein identifying the orientation for the content on the display includes identifying a location for the content on the display.

4. The method of claim 2, wherein the action overlays the content on the object.

5. The method of claim 2,
wherein identifying the orientation for the content on the display of the device comprises:
identifying a depth, a distance, a direction, or a size of the object in the image; and
identifying the orientation based on the depth, the distance, the direction, or the size of the object in the image.

6. The method of claim 1, wherein the action includes at least one application programming interface operation for an application.

7. The method of claim 1, wherein the application of the language model to the command and the image includes:
identifying a depth, a distance, a direction, or a size of the object to support the command.

8. The method of claim 1 further includes:
identifying a gesture;
wherein identifying the action is based on the application of the language model to the command, the image, and the gesture.

9. A computing apparatus comprising:
a computer-readable storage medium;
at least one processor operatively coupled to the computer-readable storage medium; and
program instructions stored on the computer-readable storage medium that, when executed by the at least one processor, direct the computing apparatus to:
identify a command from a user of a device;
in response to the command, identify an image associated with a gaze of the user;
identify an action based on an application of a language model to the command and the image, the application of the language model including an identification, in the image, of an object for the command; and
initiate the action in association with the object.

10. The computing apparatus of claim 9,
wherein identifying the action based on the application of the language model to the command and the image comprises identifying content for display and an orientation for the content based on the application of the language model to the command and the image, and
wherein initiating the action comprises causing display of the content in the orientation on a display.

11. The computing apparatus of claim 10, wherein identifying the orientation for the content on the display includes identifying a location for the content on the display.

12. The computing apparatus of claim 10, wherein the action overlays the content on the object.

13. The computing apparatus of claim 10,
wherein identifying the orientation for the content on the display of the device comprises:
identifying a depth, a distance, a direction, or a size of the object in the image; and
identifying the orientation based on the depth, the distance, the direction, or the size of the object in the image.

14. The computing apparatus of claim 9, wherein the action includes at least one application programming interface operation for an application.

15. The computing apparatus of claim 9, wherein the application of the language model to the command and the image includes:
identifying a depth, a distance, a direction, or a size of the object to support the command.

16. The computing apparatus of claim 9, wherein the program instructions further direct the computing apparatus to:
identify a gesture;
wherein identifying the action based on the application of the language model to the command and the image includes identifying the action based on the application of the language model to the command, the image, and the gesture.

17. A computer-readable storage medium storing program instructions that when executed by at least one processor cause the at least one processor to execute operations, the operations comprising:
identifying a command from a user of a device;
in response to the command, identifying an image associated with a gaze of the user;
identifying an action based on an application of a language model to the command and the image, the application of the language model including an identification, in the image, of an object for the command; and
initiating the action in association with the object.

18. The computer-readable storage medium of claim 17,
wherein identifying the action based on the application of the language model to the command and the image comprises identifying content for display and an orientation for the content based on the application of the language model to the command and the image, and
wherein initiating the action comprises causing display of the content in the orientation on the display.

19. The computer-readable storage medium of claim 18, wherein identifying the orientation for the content on the display includes identifying a location for the content on the display.

20. The computer-readable storage medium of claim 17, wherein the application of the language model to the command and the image includes:
identifying a depth, a distance, a direction, or a size of the object to support the command.
